(19) United States
(12) Patent Application Publication
(10) Pub. No.: US 2026/0217152 A1
(43) Pub. Date: Jul. 30, 2026

(54) VALIDATION OF ELECTRIC VEHICLE CHARGING STATION STATUSES

(71) Applicant: Liikennevirta Oy / Virta Ltd, Helsinki (FI)

(72) Inventors: Jani HENRIKSSON, Espoo (FI); Kien BUI, Espoo (FI)

(73) Assignee: Liikennevirta Oy / Virta Ltd, Helsinki (FI)

(21) Appl. No.: 19/147,873

(22) PCT Filed: Jan. 12, 2024
(86) PCT No.: PCT/FI2024/050012

§ 371 Date: Jul. 14, 2025

(30) Foreign Application Priority Data
Jan. 17, 2023 (FI) 20235040

(51) Int. Cl. B60L 53/68; B60L 53/67; G06F 16/23

(52) U.S. Cl. CPC B60L 53/68; B60L 53/67; G06F 16/2365

(57) ABSTRACT

The present disclosure relates to a technical solution that allows validating whether the status of an EV charging station which is pre-recorded in a database matches its actual status. Said validation is based on receiving and analyzing additional data from the EV charging station, such as energy meter readings and heartbeats. If the additional data is determined to be inconsistent with the pre-recorded status of the EV charging station, then the EV charging station is requested to report its actual status which is then used to decide whether the database should be updated in terms of the status of the EV charging station. By so doing, it is possible to provide more reliable energy management in an EV charging system, increase its reliability, decrease its dangerous overloading, and reduce the amount of potential legal disputes considering liabilities and services not working as promised.

### TECHNICAL FIELD

The present disclosure relates generally to electric vehicles. More specifically, the present disclosure relates to an apparatus and method for validating an electric vehicle (EV) charging station status, as well as to a corresponding computer program.

### BACKGROUND

As a rule, an EV has a self-contained battery which requires recharging for continued EV operation. Said recharging may be performed at an EV charging station. EV charging stations are managed and controlled remotely by a Charging Station Management System (CSMS) (e.g., via an Internet connection). The EV charging stations and the CSMS may communicate with each other via different communication protocols (e.g., an Open Charge Point Protocol (OCPP)).

The EV charging stations may additionally be subjected to load management services, which are used to adjust a total charging current or charging power that the EV charging stations cannot exceed for some reason (e.g., due to grid connection limitation, peak shaving, peak shifting, demand-side management, or similar load management use cases). As an example, Dynamic Load Management (DLM) may be used, which is a common technology in the EV industry to manage energy in a group of EV charging stations. A typical DLM solution is built in a way where multiple EV charging stations are grouped into a single group, whereupon the group is assigned a maximum rated current which the EV charging stations jointly are not allowed to exceed. In the meantime, the CSMS may continuously adjust the maximum rated current which the EV charging stations can use for EV charging. The CSMS may control each EV charging station individually (e.g., via an Application Programming Interface (API)).

Whenever a DLM event takes place, the CSMS may recalculate the maximum rated current for each EV charging station. DLM events are mainly caused by changes in the statuses of the EV charging stations in the same group. A typical example is that when a new EV starts charging in a group of EV charging stations, the maximum rated current of all EVs that are already charging in the group of EV charging stations must be reduced, so that it does not go over a maximum limit set by the CSMS for the group of EV charging stations.

Therefore, to provide proper DLM, it is important for the CSMS to know the actual (i.e., close to real-time) status of each EV charging station in the same group. In other words, the CSMS needs to know whether one or more EV charging stations in the same group are currently used for EV charging.

Typically, EV charging stations report their charging statuses to the CSMS via the OCPP protocol. However, scenarios are possible, in which one or more EV charging stations in the same group may fail to transmit status messages to the CSMS. It is also possible that the CSMS misses such a status message or update from a certain EV charging station. All of this can lead to a mismatch between the actual state(s) of the EV charging station(s) and the state(s) perceived by the CSMS, thereby increasing the risk of fuse blowing.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an object of the present disclosure to provide a technical solution that allows an EV charging station status to be validated.

The object above is achieved by the features of the independent claims in the appended claims. Further embodiments and examples are apparent from the dependent claims, the detailed description and the accompanying drawings.

According to a first aspect, an apparatus for validating an EV charging station status is provided. The apparatus comprises at least one processor and a memory coupled to the at least one processor. The memory is configured to store processor-executable instructions which, when executed by the at least one processor, cause the at least one processor to operate as follows. At first, the at least one processor retrieves a status of an EV charging station of interest from a pre-stored database of statuses. Each status in the database of statuses indicates whether there is an EV charging session occurring at a corresponding EV charging station. Then, the at least one processor receives, from the EV charging station of interest, data comprising: (i) an energy meter reading, or (ii) a heartbeat signal. The heartbeat signal is sent from the EV charging station of interest when there is no EV charging session occurring at the EV charging station of interest. Next, the at least one processor determines whether the data is inconsistent with the retrieved status of the EV charging station of interest. If the data is inconsistent with the retrieved status of the EV charging station of interest, the at least one processor sends a request for an actual status of the EV charging station of interest to the EV charging station of interest. Further, the at least one processor receives information about the actual status of the EV charging station of interest from the EV charging station of interest. After that, the at least one processor determines whether the actual status of the EV charging station of interest is different from the retrieved status of the EV charging station of interest. If the actual status of the EV charging station of interest is different from the retrieved status of the EV charging station of interest, the at least one processor changes the retrieved status to the actual status in the database. By so doing, it is possible to continuously crosscheck the information received from the EV charging station of interest to the information recorded in the database to determine whether the latter is up-to-date. This, in turn, may allow one to make a proper decision on a maximum charging current or power to be used at the EV charging station of interest, thereby reducing or even eliminating the risk of electrical overload (e.g., fuse flowing) at the EV charging station of interest. Furthermore, the apparatus according to the first aspect may rely completely on a cloud technology, i.e., there is no need to install additional hardware or gadgets at EV charging stations of interest. Thus, the apparatus according to the first aspect is hardware-agnostic and does not depend on certain communication protocols.

In one exemplary embodiment of the first aspect, the at least one processor is further configured, upon changing the retrieved status to the actual status in the database, to determine whether the EV charging station of interest belongs to a group of EV charging stations for which a total current does not have to exceed a threshold value. If this is the case, the at least one processor is further configured to calculate a current adjustment for each EV charging station of the group of EV charging stations such that the total current of the group of EV charging stations does not exceed the threshold value, and to report the current adjustment to each EV charging station of the group of EV charging stations. By so doing, it is possible to provide proper DLM in the group of EV charging stations. In other words, it is possible to avoid the problem when the EV charging stations in the same group jointly use a lot more charging current or power than they should.

In one exemplary embodiment of the first aspect, the retrieved status indicates that there is no EV charging session occurring at the EV charging station of interest, and the data comprises the energy meter reading comprising an actual charging current value or an actual charging power value. In this embodiment, the at least one processor is configured to determine that the data is inconsistent with the retrieved status of the EV charging station of interest if: (i) the actual charging current value is greater than 0 A by a threshold value, or (ii) the actual charging power value is greater than 0 W by a threshold value. By so doing, the apparatus according to the first aspect may efficiently determine that the retrieved status of the EV charging station of interest is not up-to-date and needs to be validated.

In another exemplary embodiment of the first aspect, the retrieved status indicates that there is an EV charging session occurring at the EV charging station of interest. In this embodiment, the at least one processor is configured to determine that the data is inconsistent with the retrieved status of the EV charging station of interest if the data comprises the heartbeat signal. By so doing, the apparatus according to the first aspect may efficiently determine that the retrieved status of the EV charging station of interest is not up-to-date and needs to be validated.

According to a second aspect, a method for validating an EV charging station status is provided. The method starts with the step of retrieving a status of an EV charging station of interest from a pre-stored database of statuses. Each status in the database of statuses indicates whether there is an EV charging session occurring at a corresponding EV charging station. Then, the method proceeds to the step of receiving, from the EV charging station of interest, data comprising: (i) an energy meter reading, or (ii) a heartbeat signal. The heartbeat signal is sent from the EV charging station of interest when there is no EV charging session occurring at the EV charging station of interest. Further, the method goes on to the step of determining whether the data is inconsistent with the retrieved status of the EV charging station of interest. If the data is inconsistent with the retrieved status of the EV charging station of interest, the method proceeds to the step of sending a request for an actual status of the EV charging station of interest to the EV charging station of interest. After that, the method goes on to the steps of receiving information about the actual status of the EV charging station of interest from the EV charging station of interest and determining whether the actual status of the EV charging station of interest is different from the retrieved status of the EV charging station of interest. If the actual status of the EV charging station of interest is different from the retrieved status of the EV charging station of interest, the method proceeds to the step of changing the retrieved status to the actual status in the database. By so doing, it is possible to continuously crosscheck the information received from the EV charging station of interest to the information recorded in the database to determine whether the latter is up-to-date. This, in turn, may allow one to make a proper decision on a maximum charging current or power to be used at the EV charging station of interest, thereby reducing or even eliminating the risk of electrical overload (e.g., fuse flowing) at the EV charging station of interest. Furthermore, the method according to the second aspect may rely completely based on a cloud technology, i.e., there is no need to install additional hardware or gadgets at EV charging stations of interest. Thus, the method according to the second aspect is hardware-agnostic and does not rely on certain communication protocols.

In one exemplary embodiment of the second aspect, it is further determined whether the EV charging station of interest belongs to a group of EV charging stations for which a total current does not have to exceed a threshold value. If the EV charging station of interest belongs to the group of EV charging stations, a current adjustment is calculated for each EV charging station of the group of EV charging stations such that the total current of the group of EV charging stations does not exceed the threshold value. The current adjustment is then reported to each EV charging station of the group of EV charging stations. By so doing, it is possible to provide proper DLM in the group of EV charging stations. In other words, it is possible to avoid the problem when the EV charging stations in the same group jointly use a lot more charging current or power than they should.

In one exemplary embodiment of the second aspect, the retrieved status indicates that there is no EV charging session occurring at the EV charging station of interest, and the data comprises the energy meter reading comprising an actual charging current value or an actual charging power value. In this embodiment, the data is determined to be inconsistent with the retrieved status of the EV charging station of interest if: (i) the actual charging current value is greater than 0 A by a threshold value, or (ii) the actual charging power value is greater than 0 W by a threshold value. By so doing, it is possible to efficiently determine that the retrieved status of the EV charging station of interest is not up-to-date and needs to be validated.

In another exemplary embodiment of the second aspect, the retrieved status indicates that there is an EV charging session occurring at the EV charging station of interest. In this embodiment, the data is determined to be inconsistent with the retrieved status of the EV charging station of interest if the data comprises the heartbeat signal. By so doing, it is possible to efficiently determine that the retrieved status of the EV charging station of interest is not up-to-date and needs to be validated.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any computing device, like the apparatus according to the first aspect.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of an EV charging system in which a group of EV charging stations is subjected to Dynamic Load Management (DLM) by using a Charging Station Management System (CSMS);

FIGS. 2A-2C schematically explain a possible scenario in an EV charging system, in which the status of an EV charging station previously recorded in a CSMS becomes outdated;

FIG. 3 shows a block diagram of an apparatus for validating an EV charging station status in accordance with one exemplary embodiment; and

FIG. 4 shows a flowchart of a method for operating the apparatus of FIG. 3 in accordance with one exemplary embodiment.

### DETAILED DESCRIPTION

Various embodiments of the present disclosure are further described in more detail with reference to the accompanying drawings. However, the present disclosure can be embodied in many other forms and should not be construed as limited to any certain structure or function disclosed in the following description. In contrast, these embodiments are provided to make the description of the present disclosure detailed and complete.

According to the present disclosure, it will be apparent to those skilled in the art that the scope of the present disclosure covers any embodiment, which is disclosed herein, irrespective of whether this embodiment is implemented independently or in concert with any other embodiment of the present disclosure. For example, the apparatus and method disclosed herein can be implemented by using any numbers of the embodiments provided herein. Furthermore, it should be understood that any embodiment of the present disclosure can be implemented using one or more of the elements or operations presented in the appended claims.

The word “exemplary” is used herein in the meaning of “used as an illustration”. Unless otherwise stated, any embodiment described herein as “exemplary” should not be construed as preferable or having an advantage over other embodiments.

As used in the exemplary embodiments disclosed herein, an electric vehicle or EV may refer to different kinds of electricity-driven vehicles, such as electric cars, aircrafts and vessels. With that said, an EV charging station may refer to a station properly deployed to charge corresponding one of these kinds of EVs. For example, the EV charging station may be arranged along roads to charge electric cars. In case of electric aircrafts, the EV charging station may be located at an airport. Being used for electric vessels, the EV charging station may be located at a seaport. It should also be noted that the EV charging station may be equipped with more than one charging point (CP), for which reason the EV charging station may charge more than one EV simultaneously.

During its operation, an EV charging station may communicate with a Charging Station Management System (CSMS) via a communication protocol, such as an Open Charge Point Protocol (OCPP). More specifically, the EV charging station may report its charging status to the CSMS. Typical examples of the reported charging status are defined in the OCPP in the following form: “Available” (i.e., when the EV charging station becomes available for a new EV), “Preparing” (i.e., when the EV charging station becomes no longer available for a new EV but there is no ongoing EV charging session yet; in other words, a CP connector is in a preparing state when a EV user applies his/her ID card and inserts a charging cable to the CP connector), “Charging” (i.e., when there is an ongoing EV charging session), “Finishing” (i.e., when the EV charging session has stopped at the CP connector, but the CP connector is not yet available for a new EV—e.g., the charging cable has not been removed or the charged EV vehicle has not left the EV charging station), “SuspendedEV” (i.e., when an EV is connected to an EV supply equipment (EVSE) at the EV charging station, and the EVSE is offering energy but the EV is not taking any energy), “SuspendedEVSE” (i.e., when the EV is connected to the EVSE but the EVSE is not offering energy to the EV, e.g., due to a smart charging restriction, local supply power constraints, etc.), and so on. If the EV charging station belongs to a group of EV charging stations for which a maximum rated current is set, the CSMS may use the reported charging status from that EV charging station (and from the rest EV charging stations of the group) to properly perform Dynamic Load Management in the group.

In addition to its charging status, the EV charging station may also report other valuable data to the CSMS, such as energy meter readings and heartbeats. The energy meter readings are data recorded by a built-in energy meter, which may tell the following information about a current EV charging session: an amount of charged energy, how much current is flowing through each phase, and what is an actual charging current or power value. The heartbeats, on the other hand, are used as a means for the charging station to let the CSMS know that it is online and connected to the CSMS. In other words, the heartbeat may be considered as a signal that is generated by the EV charging station at regular intervals to indicate that the EV charging station is operating correctly.

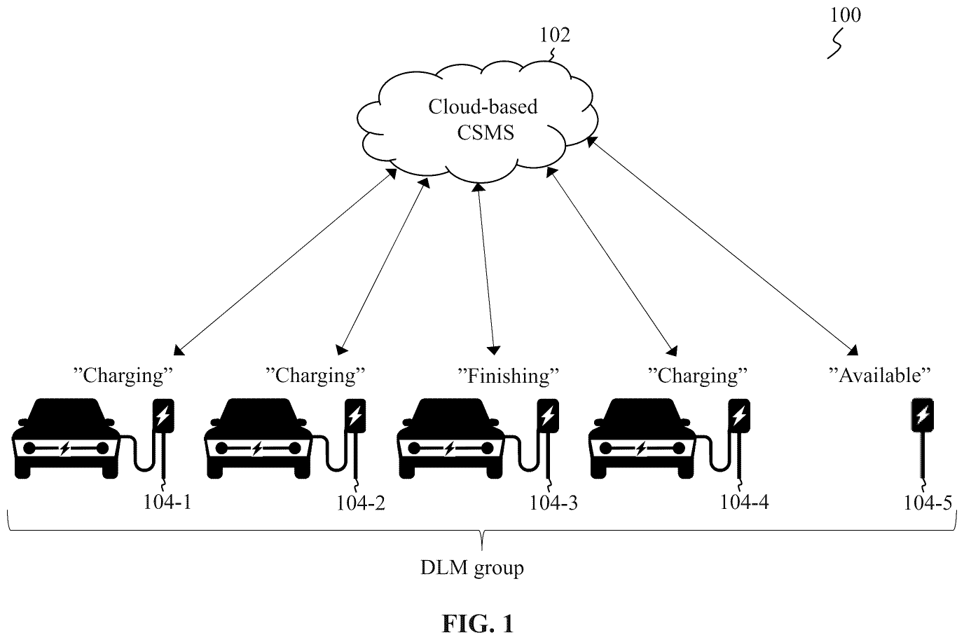

FIG. 1 shows a block diagram of an EV charging system 100 in which a group of EV charging stations is subjected to DLM by using a CSMS 102. In this example, the group of EV charging stations (or DLM group for short) comprises five EV charging stations 104-1, 104-2, 104-3, 104-4, 104-5, each of which is equipped with a single CP. The CSMS 102 is assumed to be based on a cloud technology and configured to set a maximum rated current for the DLM group. To provide proper DLM in the DLM group, the CSMS 102 should receive charging status reports from the EV charging stations 104-1, 104-2, 104-3, 104-4, 104-5 first and then to evenly divide the maximum rated current between those of them which are now in the “Charging” status (i.e., between the EV charging stations 104-1, 104-2 and 104-4).

However, the existing EV charging systems (like the system 100) may face the following problems: at times, an EV charging station may fail to transmit a charging status message to the CSMS, indicating whether it is, for example, “Charging”, “Available”, or “Finishing”; or the CSMS may miss such a charging status message or update from the EV charging station. This may lead into a mismatch between the actual status of the EV charging station and that perceived by the CSMS itself. In this scenario, DLM cannot be provided in an optimal way (or at all). In the worst case, this may cause a danger to the whole electric system if the EV charging stations use a lot more charging power than they should.

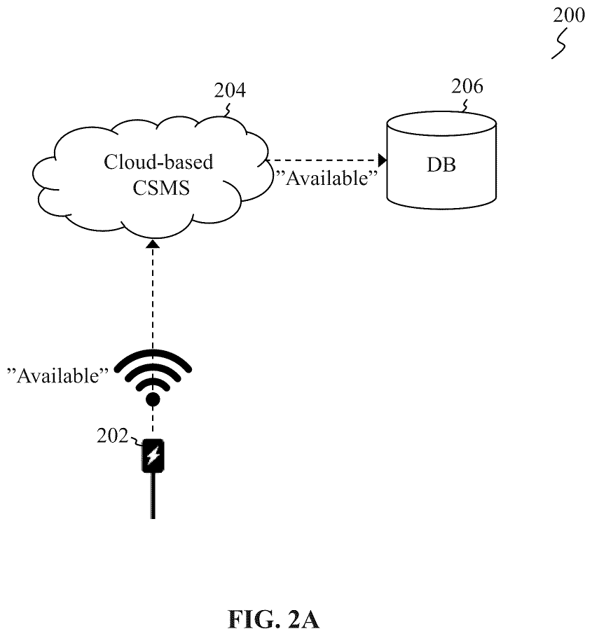

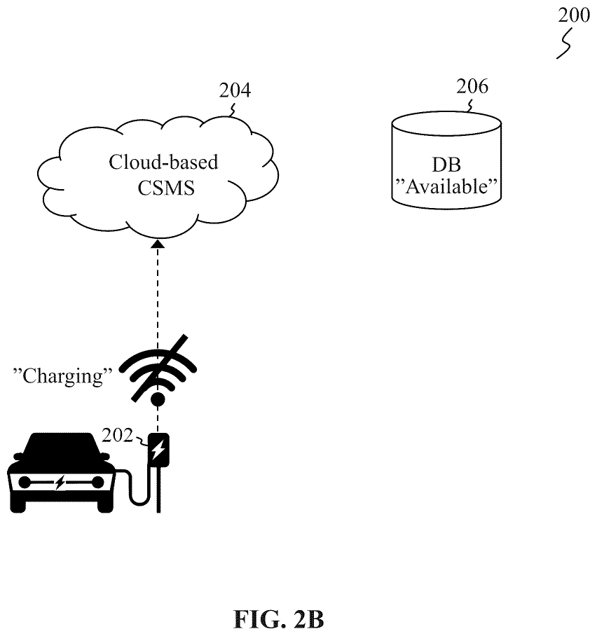

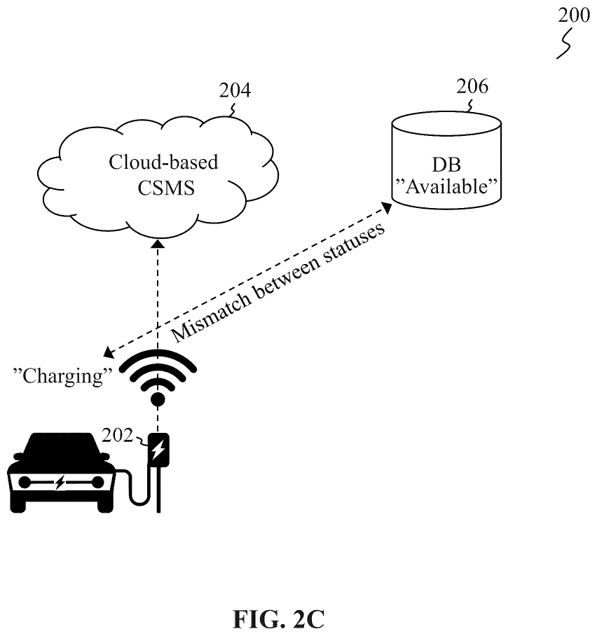

FIGS. 2A-2C schematically explain a possible scenario in an EV charging system 200, in which the status of an EV charging station 202 previously recorded in a CSMS 204 becomes outdated. In FIG. 2A, the EV charging station 202 is assumed to be in the “Available” status, which is reported via a wireless connection to the CSMS 204. In response, the CSMS 204 creates a corresponding entry in a database 206. Then, in FIG. 2B, it is assumed that the EV charging station 202 updates its status (i.e., its status changes from “Available” to “Charging”), but this status update cannot reach the CSMS 204, for example, due to momentary connection loss. Thus, since the status of the EV charging station 202 before the connection loss was “Available” and during an offline period it has changed to “Charging”, the CSMS 204 will still consider it “Available” until the EV charging station 202 reports a new status update after its wireless connection with the CSMS 204 is re-established (it should be noted that status updates may not take place often, depending on EV charging stations). In FIG. 2C, it is assumed that the wireless connection is re-established, and the CSMS 204 receives the status update from the EV charging station 202 and finds out that the latest status stored in the database 206, i.e., “Available”, no longer matches the actual status of the EV charging station 202, i.e., “Charging”.

As follows from the above-described scenario, during the connection loss, the CSMS 204 will consider the EV charging station 202 as being in the “Available” status even though it is charging an EV. This may lead to a situation where the CSMS 204 will decide to temporarily (i.e., until the wireless connection is re-established, as shown in FIG. 2C) redirect all or most of the charging current from the EV charging station 202 to one or more other EV charging stations which are assumed to be in the “Charging” status. This redirection, in turn, may slow down or even stop the charging of the EV at the EV charging station 202, which may make cause a EV driver to refuse from charging at all. Moreover, if the EV charging station 202 belongs to a DLM group (like the one shown in FIG. 1), the mismatch between the actual status of the EV charging station 202 and its status previously recorded in the database 206 may lead to a situation where the CSMS 204 will distribute all the available charging current or power between those EV charging stations of the DLM group which are assumed to be in the “Charging” status, without considering the EV charging station 202. This may eventually increase the risk of exceeding the preset maximum rated current for the group (since the CSMS 204 does not know that the EV charging station 202 is still using some of the charging current to charge the EV).

The exemplary embodiments disclosed herein provide a technical solution that allows mitigating or even eliminating the above-sounded drawbacks peculiar to the prior art. In particular, the technical solution allows validating whether the status of an EV charging station which is pre-recorded in a database matches its actual status. Said validation is based on receiving and analyzing additional data from the EV charging station, such as energy meter readings and heartbeats. If the additional data is determined to be inconsistent with the pre-recorded status of the EV charging station, then the EV charging station is requested to report its actual status which is then used to decide whether the database should be updated in terms of the status of the EV charging station. By so doing, it is possible to provide more reliable energy management (e.g., DLM) in an EV charging system, increase its reliability, decrease its dangerous overloading, as well as reduce the amount of potential legal disputes considering liabilities and services not working as promised. Indirectly, this would mean also less support costs and increased customer satisfaction.

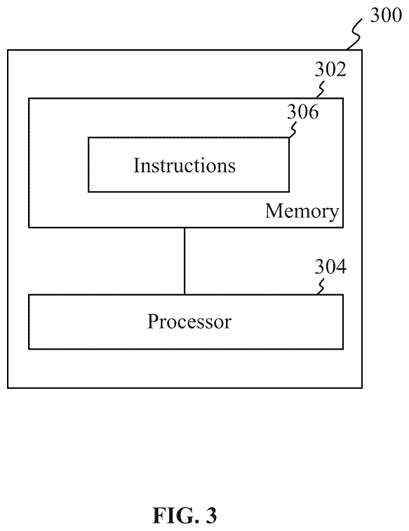

FIG. 3 shows a block diagram of an apparatus 300 for validating an EV charging station status in accordance with one exemplary embodiment. The apparatus 300 is intended to be integrated into a remote monitoring center (e.g., such as the CSMS 102 or 204) serving one or more EV charging stations. As shown in FIG. 3, the apparatus 300 comprises a memory 302 and a processor 304 coupled to the memory 302. The memory 302 stores processor-executable instructions 306 which, when executed by the processor 304, cause the processor 304 to perform the aspects of the present disclosure, as will be described below in more detail. It should be noted that the number, arrangement, and interconnection of the constructive elements constituting the apparatus 300, which are shown in FIG. 3, are not intended to be any limitation of the present disclosure, but merely used to provide a general idea of how the constructive elements may be implemented within the apparatus 300. For example, the processor 304 may be replaced with several processors, as well as the memory 302 may be replaced with several removable and/or fixed storage devices, depending on particular applications. Furthermore, in some embodiments, the apparatus 300 may further comprise a transceiver which may be implemented as two individual devices, with one for a receiving operation and another for a transmitting operation. Irrespective of its implementation, the transceiver is intended to be capable of performing different operations required to perform the data reception and transmission, such, for example, as signal modulation/demodulation, encoding/decoding, etc. In other embodiments, the transceiver may be part of the processor 304 itself.

The processor 304 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 304 may be implemented as any combination of one or more of the aforesaid. As an example, the processor 304 may be a combination of two or more microprocessors.

The memory 302 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 306 stored in the memory 302 may be configured as a computer-executable program code which causes the processor 304 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 302) on the fly.

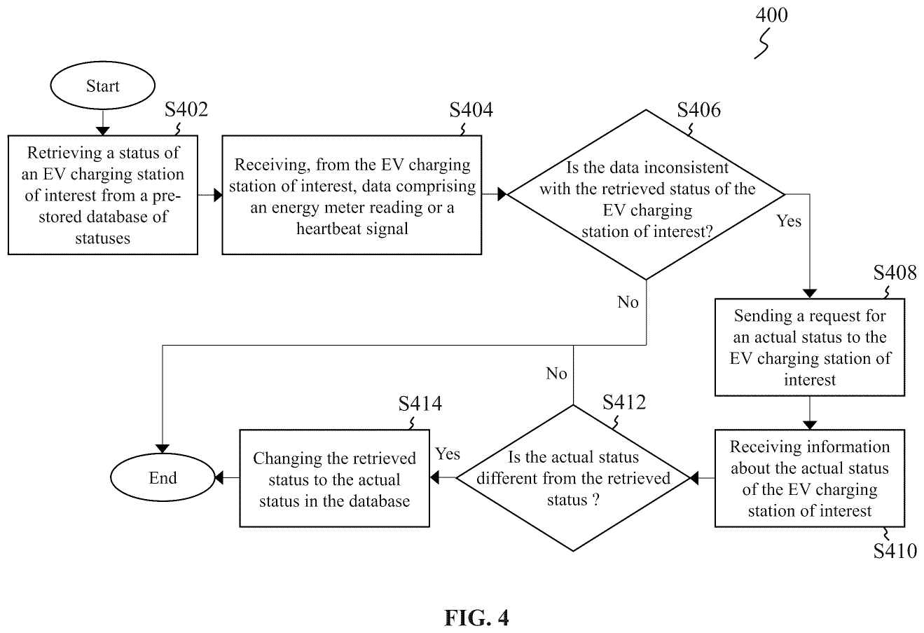

FIG. 4 shows a flowchart for a method 400 for operating the apparatus 300 in accordance with one exemplary embodiment. The method 400 is intended to be performed by the processor 304 of the apparatus 200 when the processor 304 is caused to execute the processor executable instructions 306.

The method 400 starts with a step S402, in which the processor 304 starts monitoring changes in the status of an EV charging station of interest (e.g., to set a new maximum rated current for a certain DLM group which the EV charging station of interest may belong to). For this purpose, the processor 304 retrieves the latest status of the EV charging station of interest from a pre-stored database of statuses (where each status indicates whether there is an EV charging session occurring at a corresponding EV charging station). As noted earlier, the status of the EV charging station of interest may be represented by any of “Available”, “Charging”, “Finishing”, etc. The database of statuses may be formed based on latest status reports or messages from EV charging stations. It should be noted that each EV charging station may report a status change only when its status actually changes, and not, e.g., every 5 minutes. In other words, each EV charging station may not necessarily send a new “interim” status report saying that “It is still charging”. Thus, if the apparatus 400 (i.e., the processor 304) misses the status report, then the apparatus 400 (i.e., the processor 304) will be clueless on what the EV charging station of interest is doing at the moment (since the EV charging station will not report the status again until it changes to something else).

Then, the method 400 proceeds to a step S404, in which the processor 304 receives additional valuable (in terms of the status validation) data from the EV charging station of interest. The additional data may comprise an energy meter reading (e.g., an actual charging current or power value) or a heartbeat signal. Furthermore, the EV charging station of interest may report specific additional data (e.g., electric current per phase and power) for a specific interval.

Energy meter readings are usually transmitted from the EV charging station of interest at a configurable interval during an EV charging session. For example, the interval of how often the EV charging station of interest reports the energy meter readings may be set to 60 seconds and configured as the “MeterValueSampleInterval” value defined in the OCPP protocol as follows:
“Interval between sampling of metering (or other) data, intended to be transmitted by “MeterValues” PDUs.
For charging session data (ConnectorId>0), samples are acquired and transmitted periodically at this interval from the start of the charging transaction.
A value of “0” (numeric zero), by convention, is to be interpreted to mean that no sampled data should be transmitted”.

At the same time, the EV charging station of interest may also be configured to report the additional data even outside of the EV charging session, if required.

As for heartbeat signals (or simply “heartbeats” for short), the EV charging station of interest is assumed to transmit them outside of the EV charging session for a certain interval to let the apparatus 300 know that the EV charging station of interest is still wirelessly connected to it. Thus, if the additional data comprises the heartbeat signal only, it will mean that there is no EV charging session occurring at the EV charging station of interest (i.e., the EV charging station of interest is in the “Available” status).

It should be noted that the EV charging station of interest may be pre-configured (i.e., factory-configured) to send all or some of the above-described additional data to the processor 304, or it may be configured by the processor 304 itself to do so (e.g., whenever the EV charging station of interest establishes a wireless connection with the processor 304). Further, the method 400 goes on to a step S406, in which the processor 304 determines whether the additional data is inconsistent with the retrieved status of the EV charging station of interest. If the additional data is consistent with the retrieved status of the EV charging station of interest, then the method terminates since the retrieved status is still relevant. However, if the data is inconsistent with the retrieved status of the EV charging station of interest, the method proceeds to a next step S408. Said inconsistency may occur, for example, in the following scenarios:
1) The latest status stored in the database of statuses is as follows: “Available”, but the EV charging station of interest has reported the actual charging current/power value greater than >0 A/0 W (e.g., greater than 0 A/0 W by a threshold value). Hence, there is a possibility that the EV charging station of interest is actually in the “Charging” status.
2) The latest status stored in the database of statuses is as follows: “Charging”, but the EV charging station of interest has reported the heartbeat signal and no energy meter reading. Hence, there is a possibility that the EV charging station of interest is no longer in the “Charging” status. In reality, its status could be, for example, “SuspendedEV”, meaning that an EV is fully charged.
3) The latest status stored in the database of statuses is as follows: “SuspendedEV/EVSE” or “Finishing”, but the EV charging station of interest has reported the actual charging current/power value greater than 0 A/0 W (e.g., greater than 0 A/0 W by a threshold value). Hence, there is a possibility that the EV charging station of interest is actually in the “Charging” status.

In the step S408, the processor 304 sends a request for the actual status of the EV charging station of interest to the EV charging station of interest. After that, the method 400 goes on to a step S410, in which the processor 304 receives information about the actual status of the EV charging station of interest from the EV charging station of interest. The actual status of the EV charging station of interest is further compared to its retrieved status in a next step S412. If the actual status of the EV charging station of interest matches its retrieved status, then the method 400 terminates (in this case, the additional data from the EV charging station of interest could have been erroneously formed by the EV charging station of interest itself or incorrectly interpreted by the processor 304). However, if the actual status of the EV charging station of interest is different from its retrieved status, the method 400 proceeds to a step S414, in which the processor 304 rectifies the status of the EV charging station of interest in the database of statuses.

In one embodiment, the method 400 may comprise, after the step S414, additional steps, in which the processor 304 determines whether the EV charging station of interest belongs to any DLM group (i.e., a group of EV charging stations for which a total current does not have to exceed a threshold value) and, if this is the case, calculates and reports a current adjustment to each EV charging station of the DLM group. The current adjustment is calculated based on the condition that the total current of the DLM group should not exceed the threshold value.

Those skilled in the art should understand that each step, block or operation of the method 400, or any combinations of the steps, blocks or operations, can be implemented by various means, such as hardware, firmware, and/or software. As an example, one or more of the steps, blocks or operations described above can be embodied by computer executable instructions, data structures, program modules, and other suitable data representations. Furthermore, the computer executable instructions which embody the steps, blocks or operations described above can be stored on a corresponding data carrier and executed by at least one processor like the processor 304 of the apparatus 300. This data carrier can be implemented as any computer-readable storage medium configured to be readable by said at least one processor to execute the computer executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An apparatus for validating an electric vehicle (EV) charging station status, comprising:
at least one processor; and
a memory coupled to the at least one processor and storing processor-executable instructions which, when executed by the at least one processor, cause the at least one processor to:
retrieve a status of an EV charging station of interest from a pre-stored database of statuses, each status in the database of statuses indicating whether there is an EV charging session occurring at a corresponding EV charging station;
receive, from the EV charging station of interest, data comprising: (i) an energy meter reading, or (ii) a heartbeat signal, the heartbeat signal being sent from the EV charging station of interest when there is no EV charging session occurring at the EV charging station of interest;
determine whether the data is inconsistent with the retrieved status of the EV charging station of interest;
if the data is inconsistent with the retrieved status of the EV charging station of interest, send a request for an actual status of the EV charging station of interest to the EV charging station of interest;
receive, from the EV charging station of interest, information about the actual status of the EV charging station of interest;
determine whether the actual status of the EV charging station of interest is different from the retrieved status of the EV charging station of interest; and
if the actual status of the EV charging station of interest is different from the retrieved status of the EV charging station of interest, change the retrieved status to the actual status in the database.

2. The apparatus of claim 1, wherein the at least one processor is further configured, upon changing the retrieved status to the actual status in the database, to:
determine whether the EV charging station of interest belongs to a group of EV charging stations for which a total current does not have to exceed a threshold value;
if the EV charging station of interest belongs to the group of EV charging stations, calculate a current adjustment for each EV charging station of the group of EV charging stations such that the total current of the group of EV charging stations does not exceed the threshold value; and
report the current adjustment to each EV charging station of the group of EV charging stations.

3. The apparatus of claim 1, wherein the retrieved status indicates that there is no EV charging session occurring at the EV charging station of interest, and the data comprises the energy meter reading comprising an actual charging current value or an actual charging power value, and wherein the at least one processor is configured to determine that the data is inconsistent with the retrieved status of the EV charging station of interest if:
the actual charging current value is greater than 0 A by a threshold value; or
the actual charging power value is greater than 0 W by a threshold value.

4. The apparatus of claim 1, wherein the retrieved status indicates that there is an EV charging session occurring at the EV charging station of interest, and wherein the at least one processor is configured to determine that the data is inconsistent with the retrieved status of the EV charging station of interest if the data comprises the heartbeat signal.

5. A method for validating an electric vehicle (EV) charging station status, comprising:
retrieving a status of an EV charging station of interest from a pre-stored database of statuses, each status in the database of statuses indicating whether there is an EV charging session occurring at a corresponding EV charging station;
receiving, from the EV charging station of interest, data comprising: (i) an energy meter reading, or (ii) a heartbeat signal, the heartbeat signal being sent from the EV charging station of interest when there is no EV charging session occurring at the EV charging station of interest;
determining whether the data is inconsistent with the retrieved status of the EV charging station of interest;
if the data is inconsistent with the retrieved status of the EV charging station of interest, sending a request for an actual status of the EV charging station of interest to the EV charging station of interest;
receiving, from the EV charging station of interest, information about the actual status of the EV charging station of interest;
determining whether the actual status of the EV charging station of interest is different from the retrieved status of the EV charging station of interest; and
if the actual status of the EV charging station of interest is different from the retrieved status of the EV charging station of interest, changing the retrieved status to the actual status in the database.

6. The method of claim 5, further comprising, after said changing the retrieved status to the actual status in the database:
determining whether the EV charging station of interest belongs to a group of EV charging stations for which a total current does not have to exceed a threshold value;
if the EV charging station of interest belongs to the group of EV charging stations, calculating a current adjustment for each EV charging station of the group of EV charging stations such that the total current of the group of EV charging stations does not exceed the threshold value; and
reporting the current adjustment to each EV charging station of the group of EV charging stations.

7. The method of claim 5, wherein the retrieved status indicates that there is no EV charging session occurring at the EV charging station of interest, and the data comprises the energy meter reading comprising an actual charging current value or an actual charging power value, and wherein the data is determined to be inconsistent with the retrieved status of the EV charging station of interest if:
the actual charging current value is greater than 0 A by a threshold value; or
the actual charging power value is greater than 0 W by a threshold value.

8. The method of claim 5, wherein the retrieved status indicates that there is an EV charging session occurring at the EV charging station of interest, and wherein the data is determined to be inconsistent with the retrieved status of the EV charging station of interest if the data comprises the heartbeat signal.

9. A computer program product comprising a computer-readable medium that stores a computer program, wherein the computer program, when executed by at least one processor, causes the at least one processor to perform the method of claim 5.
